(19) United States
(12) Patent Application Publication
(10) Pub. No.: US 2018/0157127 A1
(43) Pub. Date: Jun. 7, 2018

(54) LIQUID CRYSTAL DISPLAY PANEL AND MANUFACTURING METHOD THEREOF

(71) Applicant: SHENZHEN CHINA STAR OPTOELECTRONICS TECHNOLOGY CO., LTD., Shenzhen (CN)

(72) Inventors: Chengliang YE, Shenzhen (CN); Yunglun LIN, Shenzhen (CN)

(73) Assignee: SHENZHEN CHINA STAR OPTOELECTRONICS TECHNOLOGY CO., LTD., Shenzhen (CN)

(21) Appl. No.: 15/124,363

(22) PCT Filed: Apr. 28, 2016
(86) PCT No.: PCT/CN2016/080436

§ 371 Date: Sep. 8, 2016

(30) Foreign Application Priority Data
Apr. 8, 2016 (CN) 201610219231.0

(51) Int. Cl. G02F 1/1337; G02F 1/1362; G02F 1/1339

(52) U.S. Cl. CPC G02F 1/133788; G02F 1/136209; G02F 2001/136222; G02F 1/136286; G02F 2001/13396; G02F 1/13394

(57) ABSTRACT

A liquid crystal display panel and a manufacturing method are provided. The liquid crystal display panel includes a first substrate and a second substrate. The first substrate includes a first alignment film. The first alignment film is formed by photoaligning the first alignment film material, where the data line serves as a first photoaligning reference object. The second substrate includes a second alignment film.

The second alignment film is formed by photoaligning the second alignment film, where a line connecting at least two minor spacers serves as a second photoaligning reference object.

### FIELD OF THE INVENTION

The present invention relates to the field of liquid crystal displays, and more particularly to a liquid crystal display panel and a manufacturing method thereof.

### BACKGROUND OF THE INVENTION

As shown in FIG. 1 and FIG. 2, a conventional liquid crystal display panel comprises a first substrate 10 and a second substrate 20. The first substrate 10 is, for example, a COA (color filter on array) substrate. That is, a color filter film is manufactured on an array substrate. The first substrate 10 comprises data lines 12 and scan lines 11, and black matrixes 13 are disposed on the second substrate 20.

An alignment film material is coated on an inner side of the first substrate 10. When the alignment film is formed, two left partitions and two right partitions of the four partitions 101-104 of the pixel unit are upwardly and downwardly aligned respectively by using the image sensor according to the location of data lines 12 on the both sides of the pixel unit. The alignment film material is also coated on an inner side of the second substrate 20. There are two partitions 105 and 106 on the projection of the pixel unit upon the second substrate. When the alignment film is formed, the two partitions are aligned along either a left or right side by using the image sensor according to the location of the black matrixes 13 on the both sides of the pixel unit. Finally, as shown in FIG. 3, after the two substrates are assembled, each pixel has four display domains 201-204 formed therein.

However, if the first substrate is a BOA (BM on Array) substrate, due to the BOA substrate being formed by manufacturing the black matrixes of the second substrate 20 on the array substrate, it lacks an alignment base for the image sensor on the second substrate, such that the BOA substrate cannot be aligned with an opposed substrate by using the image sensor, thereby decreasing the display effect.

Accordingly, it is necessary to provide a liquid crystal display panel and a manufacturing method thereof to solve the technical problem in the prior art.

### SUMMARY OF THE INVENTION

An object of the present invention is to provide a liquid crystal display panel and a manufacturing method thereof, so as to solve the technical problem of poor display effect caused from the BOA substrate not being able to be aligned with an opposed substrate by using the image sensor in the prior art.

In order to solve the technical problem mentioned above, the present invention provides a liquid crystal display panel, comprising:

a first substrate, comprising:

a color resist layer;

a light shield layer including a light shield block;

a device array layer, including a data line, a scan line, and a pixel unit which is defined by the data line and the scan line; and

a first alignment film which is formed by photoaligning a first alignment film material, where the data line serves as a first photoaligning reference object;

a second substrate, comprising:

a spacer assembly layer, including a major spacer and a plurality of minor spacers, wherein the major spacer and the minor spacers are arranged spaced apart from each other; and

a second alignment film which is formed by photoaligning a second alignment film material, where a line connecting at least two of the minor spacers serves as a second photoaligning reference object; and

a liquid crystal layer located between the first substrate and the second substrate,

wherein a ratio of a sum of lengths of at least two of the minor spacers to a total length is greater than or equal to 50%, the total length is an overall length of a line segment configured with at least two of the minor spacers.

In the liquid crystal display panel of the present invention, the ratio of the sum of lengths of at least two of the minor spacers to the total length is greater than or equal to 80%.

In the liquid crystal display panel of the present invention, in the second photoaligning reference object, a distance between two adjacent minor spacers is greater than 0 micrometer and is less than or equal to 80 micrometer.

In the liquid crystal display panel of the present invention, in the second photoaligning reference object, the distance between two adjacent minor spacers is greater than 6 micrometer and is less than or equal to 30 micrometer.

In the liquid crystal display panel of the present invention, a height of the major spacer is greater than a height of the minor spacers.

In the liquid crystal display panel of the present invention, the minor spacers and the major spacer are formed through a same mask process.

The present invention also provides a liquid crystal display panel, comprising:

a first substrate, comprising:

a color resist layer;

a light shield layer including a light shield block;

a device array layer, including a data line, a scan line, and a pixel unit which is defined by the data line and the scan line; and

a first alignment film which is formed by photoaligning a first alignment film material, where the data line serves as a first photoaligning reference object;

a second substrate, comprising:

a first transparent conductive layer including an alignment auxiliary region;

a second alignment film which is formed by photoaligning a second alignment film material, where the alignment auxiliary region serves as a second photoaligning reference object; and

a liquid crystal layer located between the first substrate and the second substrate.

In the liquid crystal display panel of the present invention, a location of the alignment auxiliary region corresponds to a projection location of the scan line upon the second substrate.

In the liquid crystal display panel of the present invention, the alignment auxiliary region is formed through etching the first transparent conductive layer.

In the liquid crystal display panel of the present invention, the alignment auxiliary region is formed by using a laser to irradiate the first transparent conductive layer so as to carbonize the first transparent conductive layer.

In the liquid crystal display panel of the present invention, the second substrate further comprises a spacer assembly layer which includes a major spacer and a plurality of minor spacers.

In the liquid crystal display panel of the present invention, a height of the major spacer is greater than a height of the minor spacers.

In the liquid crystal display panel of the present invention, the minor spacers and the major spacer are formed through a same mask process.

In the liquid crystal display panel of the present invention, the major spacer and the minor spacers are arranged spaced apart from each other.

The present invention also provides a manufacturing method of the liquid crystal display panel as mentioned above, comprising the following steps:

serving the data line as the first photoaligning reference object and photoaligning the first alignment film material disposed on the first substrate, so as to form the first alignment film on the first substrate;

serving the alignment auxiliary region as the second photoaligning reference object and photoaligning the second alignment film material disposed on the second substrate, so as to form the second alignment film on the second substrate; and

assembling the first substrate with the second substrate, and then disposing a liquid crystal layer between the first substrate and the second substrate.

In the method of manufacturing the liquid crystal display panel of the present invention, a location of the alignment auxiliary region corresponds to a projection location of the scan line upon the second substrate.

In the method of manufacturing the liquid crystal display panel of the present invention, the alignment auxiliary region is formed through etching the first transparent conductive layer.

In the method of manufacturing the liquid crystal display panel of the present invention, the alignment auxiliary region is formed by using a laser to irradiate the first transparent conductive layer so as to carbonize the first transparent conductive layer.

In the liquid crystal display panel and the manufacturing method thereof, the alignment accuracy for photoaligning the substrate is increased through treating the transparent conductive layer of the color filter substrate or serving the minor spacers as a photoaligning reference object, thereby increasing the display effect.

### BRIEF DESCRIPTION OF THE DRAWINGS

FIG. 1 is a diagram showing photo-alignment of a single pixel on a first substrate in the prior art.

FIG. 2 is a diagram showing photo-alignment of a single pixel on a second substrate in the prior art.

FIG. 3 is a diagram showing photo-alignment of a single pixel on a liquid crystal display panel in the prior art.

FIG. 4 is a diagram showing photo-alignment of a single pixel on a second substrate of the present invention.

FIG. 5 is a schematic diagram of a liquid crystal display panel of a first embodiment of the present invention.

FIG. 6 is a schematic diagram of a liquid crystal display panel of a second embodiment of the present invention.

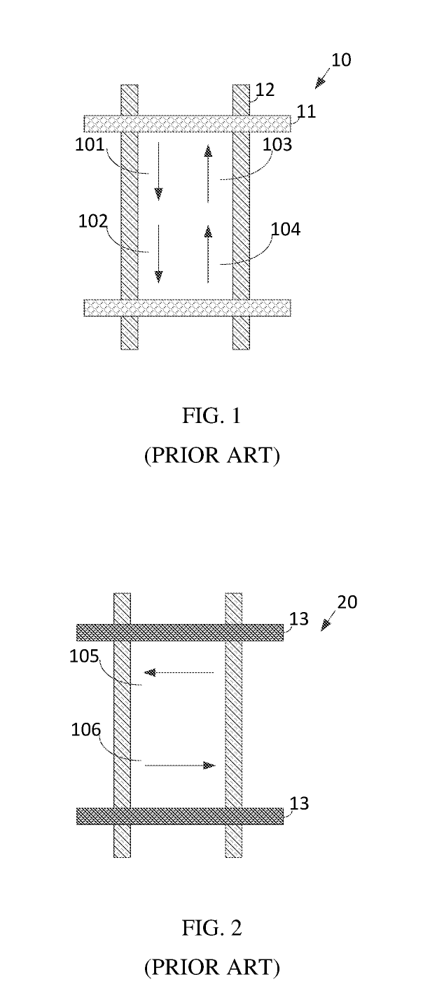

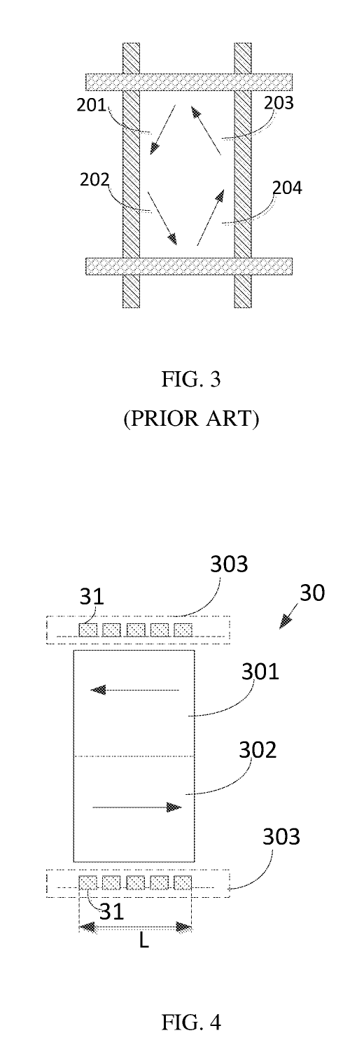

### DETAILED DESCRIPTION OF THE INVENTION

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or similar components.

Please refer to FIG. 4, which is a diagram showing photo-alignment of a single pixel on a second substrate of the present invention.

The liquid crystal display panel of the present invent comprises: a first substrate, a second substrate, and a liquid crystal layer. The liquid crystal layer is located between the first substrate and the second substrate.

The first substrate comprises a color resist layer, a light shield layer, a device array layer, and a first alignment film. The light shield layer comprises a light shield block (i.e., a black matrix). The device array layer comprises data lines, scan lines, and pixel units which are defined by the data lines and the scan lines. The first alignment film is formed by photoaligning the first alignment film material, where the data lines serve as a first photoaligning reference object.

The second substrate 30 comprises a spacer assembly layer and a second alignment film. The spacer assembly layer comprises major spacers and minor spacers. As shown in FIG. 4, the second alignment film is form by photoaligning a second alignment film material, where a line connecting at least two of the minor spacers 31 serves as a second photoaligning reference object. That is, each second photoaligning reference object is configured by the line connecting at least two of the minor spacers 31. In addition, the minor spacers 31 are located within a projection region 303 of the scan line upon the second substrate.

The first substrate may also comprise a second transparent conductive layer which comprises a pixel electrode. The second substrate may also comprise a first transparent conductive layer which comprises a common electrode.

Since there are no black matrixes disposed on the second substrate of the liquid crystal display panel in the prior art, the image sensor cannot be adjusted to sense a specific location for photoaligning, and it fails to control a machine for photoaligning according to predetermined parameters. However, due to the minor spacer having a certain height, the light-reflecting effect of an edge region thereof is different with a periphery region, such that the image sensor can track the formed second photoaligning reference object according to the light-reflecting effect for setting the specific location for photoaligning, thereby increasing the alignment accuracy for photoaligning and improving the display effect.

Preferably, a ratio of a sum of lengths of at least two of the minor spacers to a total length is greater than or equal to 50%. The total length is an overall length of a line segment configured with at least two of the minor spacers. In the example of FIG. 4, a ratio of a sum of lengths of five minor spacers 31 (i.e., a sum of lengths of minor spacers along a horizontal direction) to a total length L from the first to last minor spacer is greater than or equal to 50%. Furthermore, the ratio of the sum of lengths of at least two of the minor spacers to the total length is greater than or equal to 80%. If the minor spacers in the second photoaligning reference object are arranged to be more concentrated, the alignment accuracy for the photoaligning will be higher, thereby improving the display effect.

Preferably, the minor spacers and the major spacer are formed through a same mask process, thereby saving manufacturing cost.

Preferably, in the second photoaligning reference object, a distance between two adjacent minor spacers is greater than 0 micrometer and is less than or equal to 80 micrometer. Furthermore, the distance is in a range between 6 micrometer and 30 micrometer. If the distance is too great, it cannot satisfy the high alignment accuracy requirement.

Preferably, the major spacer and the minor spacers are arranged spaced apart from each other. That is, the location of the major spacer will not overlap the minor spacers, so as to prevent the conventional major spacer from being destroyed.

Preferably, a height of the major spacer is greater than a height of the minor spacer, so as to avoid affecting the support effect of the major spacer.

Preferably, as described in connection with FIG. 1, the first alignment film comprises the first partition 101, the second partition 102, the third partition 103, and the fourth partition 104. The alignment films of the first partition 101 and the second partition 102 are arranged along a first direction, such as being downwardly arranged. The alignment films of the third partition 103 and the fourth partition 104 are arranged along a second direction, such as being upwardly arranged.

Preferably, as shown in FIG. 4, the second alignment film comprises a fifth region 301 and a sixth region 302. The alignment film of the fifth region 301 is arranged along a third direction, such as being arrange along a leftward direction. The alignment film of the sixth region 302 is arranged along a fourth direction, such as being arrange along a rightward direction. The fifth region 301 corresponds to the first partition 101 and the third partition 103, and the sixth region 302 corresponds to the second partition 102 and the fourth partition 104, such that the pixel unit has four display domains after two substrates are assembled.

Preferably, the areas of the first partition, the second partition, the third partition, and the fourth partition are the same, and the areas of the fifth region and the sixth region are the same, such that four display domains having same area are obtained. Thus, the color of the display panel is more uniform and the contrast degree is increased.

The manufacturing method of the liquid crystal display panel of the present invention comprises the following steps.

S101, serving the data line as the first photoaligning reference object and photoaligning the first alignment film material disposed on the first substrate, so as to form the first alignment film on the first substrate.

The first alignment film material is, for example, polyimide. After the first alignment film material is irradiated by a polarized light, the first alignment film may be formed on the first substrate.

S102, serving the line connecting at least two of the minor spacers as the second photoaligning reference object and photoaligning the second alignment film material disposed on the second substrate, so as to form the second alignment film on the second substrate.

The second alignment film material is, for example, polyimide. After the second alignment film material is irradiated by a polarized light, the second alignment film may be formed on the second substrate. That is, each second photoaligning reference object is configured by the line connecting at least two of the minor spacers.

S103, assembling the first substrate with the second substrate, and then disposing a liquid crystal layer between the first substrate and the second substrate.

Preferably, a ratio of a sum of lengths of at least two of the minor spacers to a total length is greater than or equal to 50%. The total length is an overall length of a line segment configured with at least two of the minor spacers. In the example of FIG. 4, a ratio of a sum of lengths of five minor spacers 31 (i.e., a sum of lengths of minor spacers along a horizontal direction) to a total length L from the first to last minor spacer is greater than or equal to 50%. Furthermore, the ratio of the sum of lengths of at least two of the minor spacers to the total length is greater than or equal to 80%. If the minor spacers in the second photoaligning reference object are arranged to be more concentrated, the alignment accuracy for the photoaligning will be higher, thereby improving the display effect.

Preferably, the minor spacers and the major spacer are formed through a same mask process, thereby saving manufacturing cost.

Preferably, in the second photoaligning reference object, a distance between two adjacent minor spacers is greater than 0 micrometer and is less than or equal to 80 micrometer. If the distance is too great, it cannot satisfy the high alignment accuracy requirement.

Preferably, the major spacer and the minor spacers are arranged spaced apart from each other. That is, the location of the major spacer will not overlap the minor spacers, so as to prevent the conventional major spacer from being destroyed.

Preferably, a height of the major spacer is greater than a height of the minor spacer, so as to avoid affecting the support effect of the major spacer.

Preferably, as described in connection with FIG. 1, the first alignment film comprises the first partition 101, the second partition 102, the third partition 103, and the fourth partition 104. The alignment films of the first partition 101 and the second partition 102 are arranged along a first direction, such as being downwardly arranged. The alignment films of the third partition 103 and the fourth partition 104 are arranged along a second direction, such as being upwardly arranged.

Preferably, as shown in FIG. 4, the second alignment film comprises a fifth region 301 and a sixth region 302. The alignment film of the fifth region 301 is arranged along a third direction, such as being arrange along a leftward direction. The alignment film of the sixth region 302 is arranged along a fourth direction, such as being arrange along a rightward direction. The fifth region 301 corresponds to the first partition 101 and the third partition 103, and the sixth region 302 corresponds to the second partition 102 and the fourth partition 104, such that the pixel unit has four display domains after two substrates are assembled.

Preferably, the areas of the first partition, the second partition, the third partition, and the fourth partition are the same, and the areas of the fifth region and the sixth region are the same, such that four display domains having same area are obtained. Thus, the color of the display panel is more uniform and the contrast degree are increased.

According to the liquid crystal display panel and the manufacturing method thereof of the present invent, the alignment accuracy for photoaligning the substrate is increased through serving the minor spacers as the photoaligning reference object, thereby increasing the display effect.

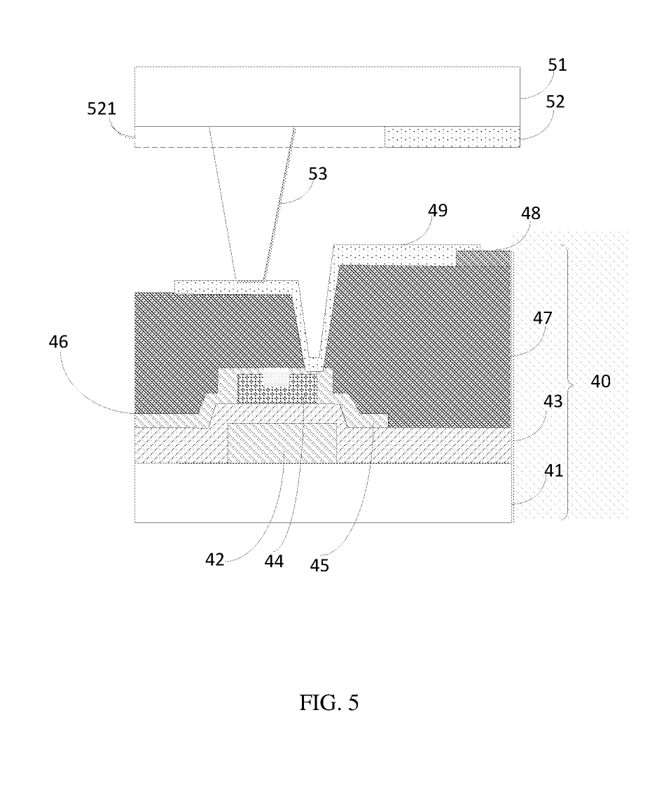

Please refer to FIG. 5, which is a schematic diagram of a liquid crystal display panel of a first embodiment of the present invention.

The liquid crystal display panel of the present invention comprises a first substrate, a second substrate, and a liquid crystal layer. The liquid crystal layer is located between the first substrate and the second substrate. The first substrate 40 is, for example, a BOA (BM on Array) substrate.

The first substrate 40 comprises a first substrate base 41 and a first metal layer 42 which is located above the first substrate base 41 and includes a gate. A portion of a gate insulation layer 43 is located on the first metal layer 42, for insulating the first metal layer 42 and an active layer 44. A portion of the active layer 44 is located on the gate insulation layer 43, for forming a channel. A second metal layer 45 is located on the active layer 44 and includes a source and a drain. A second insulation layer 46 is located on the second metal layer 45, for insulating the second metal layer 45 and a color resist layer 47. The color resist layer 47 is located on the second insulation layer 46 and includes a plurality of color resists (e.g., a red color resist, a green color resist, and a blue color resist). A through-hole is formed in the color resist layer 47. A light shield layer 48 is located on the color resist layer 47. The light shield layer 48 comprises a light shield block, i.e., a black matrix. A portion of a second transparent conductive layer 49 is located on the light shield layer 48. The first substrate also comprises a device array layer and a first alignment film. The device array layer comprises data lines, scan lines and pixel units which are defined by the data lines and the scan lines. The first alignment film is formed by photoaligning the first alignment film material, where the data lines serve as the first photoaligning reference object.

As shown in FIG. 5, the second substrate comprises a second substrate base 51, a first transparent conductive layer 52, and a second alignment film. The second substrate may also comprise a spacer assembly layer 53. The spacer assembly layer 53 comprises a major spacer and a plurality of minor spacers. The first transparent conductive layer 52 comprises an alignment auxiliary region 521. The first transparent conductive layer 52 also comprises a common electrode.

The second alignment film is formed by photoaligning the second alignment film material, where the alignment auxiliary region 521 serves as the second photoaligning reference object.

Preferably, the location of the alignment auxiliary region 521 corresponds to the projection location of the scan line upon the second substrate.

Preferably, the alignment auxiliary region 521 is acquired by etching the first transparent conductive layer 52. For example, the transparent conductive layer corresponding to the scan line is etched through a photolithography process, so as to detect the region by the image sensor and to photoalign the second alignment film material.

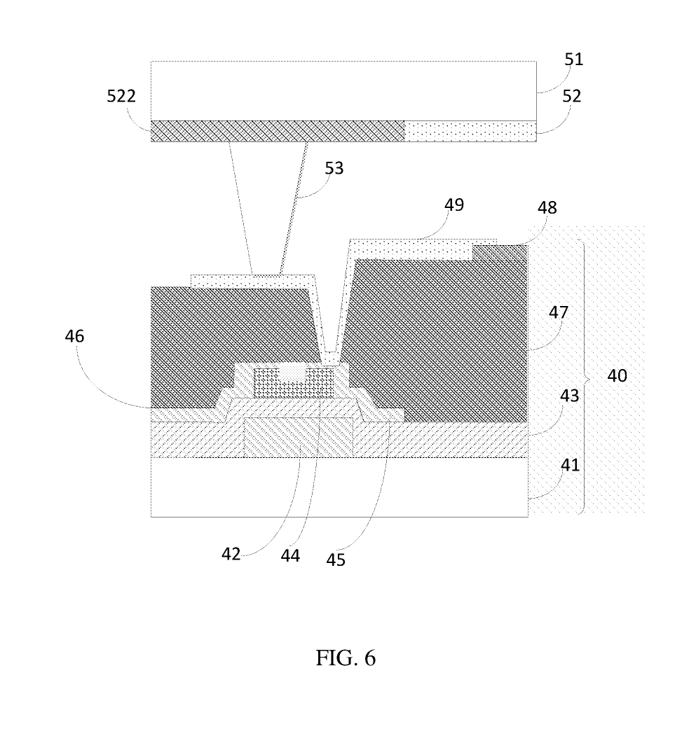

Preferably, as shown in FIG. 6, the alignment auxiliary region 522 is formed by using a laser to irradiate the first transparent conductive layer 52 so as to carbonize the transparent conductive layer. After the first transparent conductive layer corresponding to the scan line is irradiated by the laser to carbonize the transparent conductive layer, the grayscale of the carbonized region is different from the non-carbonized region, such that the region can be detected by the image sensor. Thus, the photoaligning process is achieved and the production process is shortened and the manufacturing cost is saved.

The manufacturing method of the liquid crystal display panel of the present invention comprises the following steps.

S201, serving the data line as the first photoaligning reference object and photoaligning the first alignment film material disposed on the first substrate, so as to form the first alignment film on the first substrate.

The first alignment film material is, for example, polyimide. After the first alignment film material is irradiated by a polarized light, the first alignment film may be formed on the first substrate.

S202, serving the alignment auxiliary region as the second photoaligning reference object and photoaligning the second alignment film material disposed on the second substrate, so as to form the second alignment film on the second substrate.

The second alignment film material is, for example, polyimide. After the second alignment film material is irradiated by a polarized light, the second alignment film may be formed on the second substrate.

S203, assembling the first substrate with the second substrate, and then disposing a liquid crystal layer between the first substrate and the second substrate.

Preferably, the location of the alignment auxiliary region 521 corresponds to the projection location of the scan line upon the second substrate.

Preferably, the alignment auxiliary region 521 is acquired by etching the first transparent conductive layer 52. For example, the transparent conductive layer corresponding to the scan line is etched through a photolithography process, so as to detect the region by the image sensor and to photoalign the second alignment film material.

Preferably, as shown in FIG. 6, the alignment auxiliary region 522 is formed by using a laser to irradiate the first transparent conductive layer 52 so as to carbonize the transparent conductive layer. After the first transparent conductive layer corresponding to the scan line is irradiated by the laser to carbonize the transparent conductive layer, the grayscale of the carbonized region is different from the non-carbonized region, such that the region can be detected by the image sensor. Thus, the photoaligning process is achieved and the production process is shortened and the manufacturing cost is saved.

In the liquid crystal display panel and the manufacturing method thereof, the alignment accuracy for photoaligning the substrate is increased through treating the transparent conductive layer of the color filter substrate or serving the minor spacers as a photoaligning reference object, thereby increasing the display effect.

The above descriptions are merely preferable embodiments of the present invention, and are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A liquid crystal display panel, comprising:
a first substrate, comprising:
a color resist layer;
a light shield layer including a light shield block;
a device array layer, including a data line, a scan line, and a pixel unit which is defined by the data line and the scan line; and
a first alignment film which is formed by photoaligning a first alignment film material, where the data line serves as a first photoaligning reference object; and
a second substrate, comprising:
a spacer assembly layer, including a major spacer and a plurality of minor spacers, wherein the major spacer and the minor spacers are arranged spaced apart from each other; and
a second alignment film which is formed by photoaligning a second alignment film material, where a line connecting at least two of the minor spacers serves as a second photoaligning reference object; and
a liquid crystal layer located between the first substrate and the second substrate,
wherein a ratio of a sum of lengths of at least two of the minor spacers to a total length is greater than or equal to 50%, the total length is an overall length of a line segment configured with at least two of the minor spacers.

2. The liquid crystal display panel as claimed in claim 1, wherein the ratio of the sum of lengths of at least two of the minor spacers to the total length is greater than or equal to 80%.

3. The liquid crystal display panel as claimed in claim 1, wherein in the second photoaligning reference object, a distance between two adjacent minor spacers is greater than 0 micrometer and is less than or equal to 80 micrometer.

4. The liquid crystal display panel as claimed in claim 3, wherein in the second photoaligning reference object, the distance between two adjacent minor spacers is greater than 6 micrometer and is less than or equal to 30 micrometer.

5. The liquid crystal display panel as claimed in claim 1, wherein a height of the major spacer is greater than a height of the minor spacers.

6. The liquid crystal display panel as claimed in claim 1, wherein the minor spacers and the major spacer are formed through a same mask process.

7. A liquid crystal display panel, comprising:
a first substrate, comprising:
a color resist layer;
a light shield layer including a light shield block;
a device array layer, including a data line, a scan line, and a pixel unit which is defined by the data line and the scan line; and
a first alignment film which is formed by photoaligning a first alignment film material, where the data line serves as a first photoaligning reference object; and
a second substrate, comprising:
a first transparent conductive layer including an alignment auxiliary region;
a second alignment film which is formed by photoaligning a second alignment film material, where the alignment auxiliary region serves as a second photoaligning reference object; and
a liquid crystal layer located between the first substrate and the second substrate.

8. The liquid crystal display panel as claimed in claim 7, wherein a location of the alignment auxiliary region corresponds to a projection location of the scan line upon the second substrate.

9. The liquid crystal display panel as claimed in claim 8, wherein the alignment auxiliary region is formed through etching the first transparent conductive layer.

10. The liquid crystal display panel as claimed in claim 8, wherein the alignment auxiliary region is formed by using a laser to irradiate the first transparent conductive layer so as to carbonize the first transparent conductive layer.

11. The liquid crystal display panel as claimed in claim 7, wherein the second substrate further comprises a spacer assembly layer which includes a major spacer and a plurality of minor spacers.

12. The liquid crystal display panel as claimed in claim 11, wherein a height of the major spacer is greater than a height of the minor spacers.

13. The liquid crystal display panel as claimed in claim 11, wherein the minor spacers and the major spacer are formed through a same mask process.

14. The liquid crystal display panel as claimed in claim 11, wherein the major spacer and the minor spacers are arranged spaced apart from each other.

15. A method of manufacturing the liquid crystal display panel of claim 7, comprising:
serving the data line as the first photoaligning reference object and photoaligning the first alignment film material disposed on the first substrate, so as to form the first alignment film on the first substrate;
serving the alignment auxiliary region as the second photoaligning reference object and photoaligning the second alignment film material disposed on the second substrate, so as to form the second alignment film on the second substrate; and
assembling the first substrate with the second substrate, and then disposing the liquid crystal layer between the first substrate and the second substrate.

16. The method of manufacturing the liquid crystal display panel as claimed in claim 15, wherein a location of the alignment auxiliary region corresponds to a projection location of the scan line upon the second substrate.

17. The method of manufacturing the liquid crystal display panel as claimed in claim 16, wherein the alignment auxiliary region is formed through etching the first transparent conductive layer.

18. The method of manufacturing the liquid crystal display panel as claimed in claim 16, wherein the alignment auxiliary region is formed by using a laser to irradiate the first transparent conductive layer so as to carbonize the first transparent conductive layer.
